(19) United States
(12) Patent Application Publication
(10) Pub. No.: US 2024/0278472 A1
(43) Pub. Date: Aug. 22, 2024

(54) Homestead Manufacturing System of molding an attachment to flex materia

(71) Applicant: Robert Everett Ford, Canaan, NH (US)

(72) Inventor: Robert Everett Ford, Canaan, NH (US)

(21) Appl. No.: 18/112,167

(22) Filed: Feb. 21, 2023

(51) Int. Cl. B29C 48/00; B29C 48/05; B29C 48/14; B29C 48/15; B29C 48/78; B29C 48/91

(52) U.S. Cl. CPC B29C 48/0021; B29C 48/05; B29C 48/14; B29C 48/15; B29C 48/78; B29C 48/91

(57) ABSTRACT

A means to that of a patented product within a part that of a named flex stop, to whereas the manufacturing was seen as to build a process, that of the process requiring material being attached to flex material in a productive manner of repetitive to that of a startup means to effectively enter in to tool market, as to means searched seen as high cost to achieve or none means of fast manufacturing process, The machine is of low cost extrusion to inject means parts, structure that of local hardware materials and online availability resulting in a process that to achieve and that of DC power that of direct or none direct use of grid or off grid power supplied.

### REFERENCE TO RELATED APPLICATIONS

A Supplement Support System Sleeve for a Universal Joint Improvements Provisional Application No. 63/207,298

### RELATED APPLICATIONS

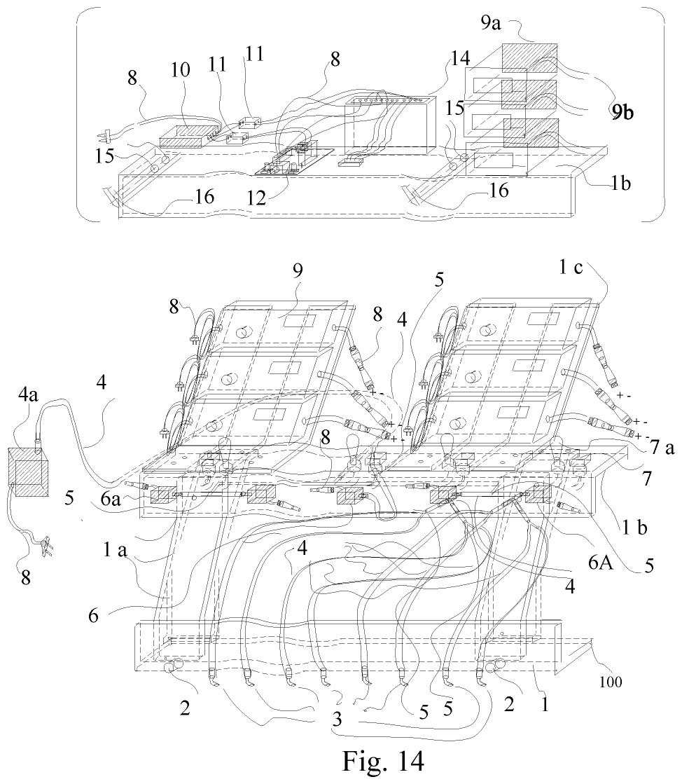

Provisional Application No. 63/207,298 FIG. 14, 1. Installation of device (Machine) system components Angled aluminum base length of system device, 63/312,441

### REFERENCE TO RELATED PATENTS

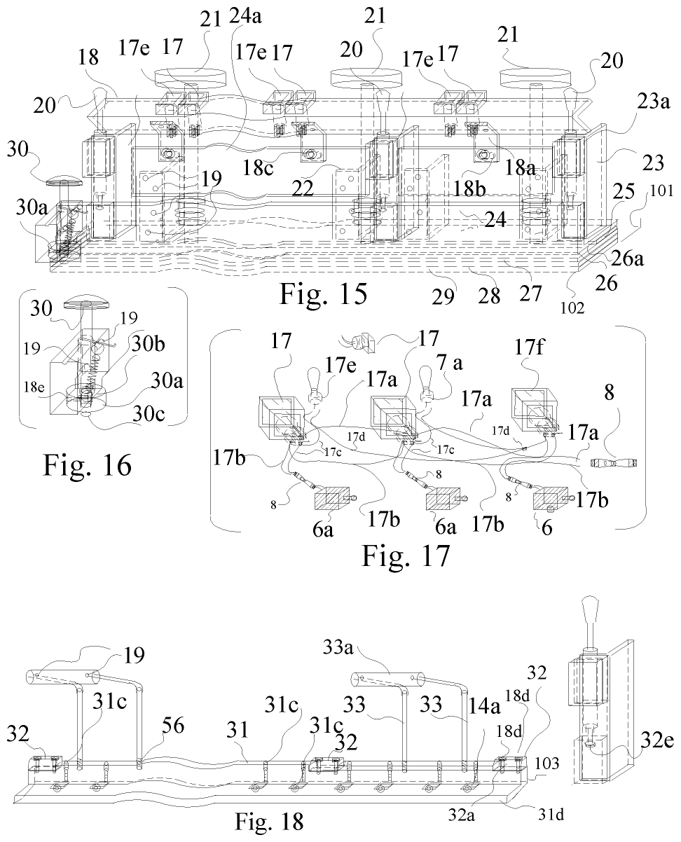

Detailed Description FIG. 1 Showing the machine assembled whereas FIG. 2. Is showing the base Provisional application titled Machine to Make Part or Parts Attaching Flexing Material filed on Jan. 15, 2019 USPS tracking (EL946056155US) to that of both the patent and provisional is that of myself as inventor. Related FIG. 15, 16, 18,-23

### BACKGROUND OF THE INVENTION

A machine for filament extrusion and extrusion filament retraction producing part or parts and attachment to that of flexible material as to belting there as a continuation of the manufacturing process of patented Supplement Support System Sleeve for a Universal Joint, U.S. Pat. No. 9,884,410 B1

### BRIEF STATEMENT OF THE INVENTION

That a manufacturing process of patented Supplement Support System Sleeve for a Universal Joint, U.S. Pat. No. 9,884,410 B1

### SUMMARY OF THE INVENTION

The machine that of describe can be described as of 4 basic components, 1. Means to injection mold plates and place material being attached to that of its base, 2. Means to mount components that of the system, 3. Means to extrude and to inject that of a productive manner, 4. Means to that of a track, a injection port guide for that of an effective means of repetitive production that of the length of the mold plates, base, track and its means to that of movement to each injection port, that of size to be a fixed machine or portable and of compatible to that of ac and dc energy use, naming a system that of Homestead Manufacturing.

### OBJECT OF THE INVENTION

That a manufacturing process of patented Supplement Support System Sleeve for a Universal Joint, U.S. Pat. No. 9,884,410 B1

### FIELD AND BACKGROUND OF THE INVENTION

That of a inventor of the patent and that to a machine in the process of manufacturing of described patent

### DESCRIPTION OF THE PRIOR ART

That of a machine of the basic approach and shape and that of a bottom and top mold plate sent in Jan. 15, 2019 tracking no. EL 946056155 and that of improvement to bottom and top mold plates as to stop improvements application Ser. No. 17/676,946

### BRIEF STATEMENT OF THE PRIOR ART

That of a machine of the basic approach and shape and that of a bottom and top mold plate sent in Jan. 15, 2019 tracking no. EL 946056155 and that of improvement to bottom and top mold plates as to stop improvements application Ser. No. 17/676,946

### BRIEF DESCRIPTION OF DRAWINGS

That of the parts made and of purchased and the assembly of as a working machine

### BRIEF DESCRIPTION OF THE FIGURES

FIG. 14 New Showing: Parts installation panel and its parts.

FIG. 15 Showing: On demand electric switch panel, prior art and new to prior art.

FIG. 16 Showing: Enlarged view to prior art improvements to bottom plate location pin.

FIG. 17 Showing: Wiring diagram for vacuum system Manual and on demand that of the same.

FIG. 18 Showing: Improvement to top mold plate, clamping, heat and movement of bottom plate.

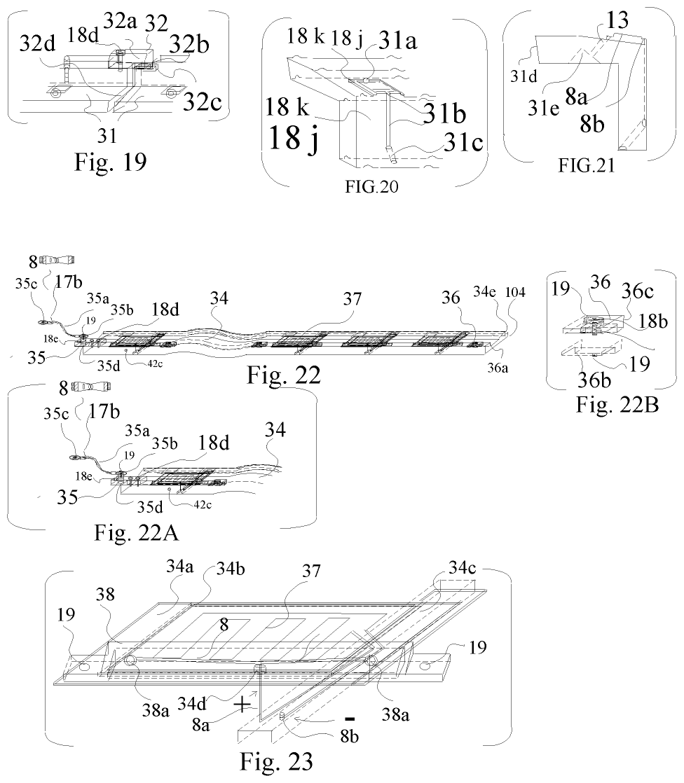

FIG. 19 Showing: Splitting of top mold plate expansion heat management.

FIG. 20 Showing: Improvements Top mold plate as to sealing.

FIG. 21 Showing: Correction of angle of relief and tip clearance to injection port.

FIG. 22 Showing: Improvements to bottom mold plate. Electric, Heat, other.

FIG. 22A Showing enlarged view: Improvements to Prior art bottom mold plate.

FIG. 23 Showing: On demand heating system.

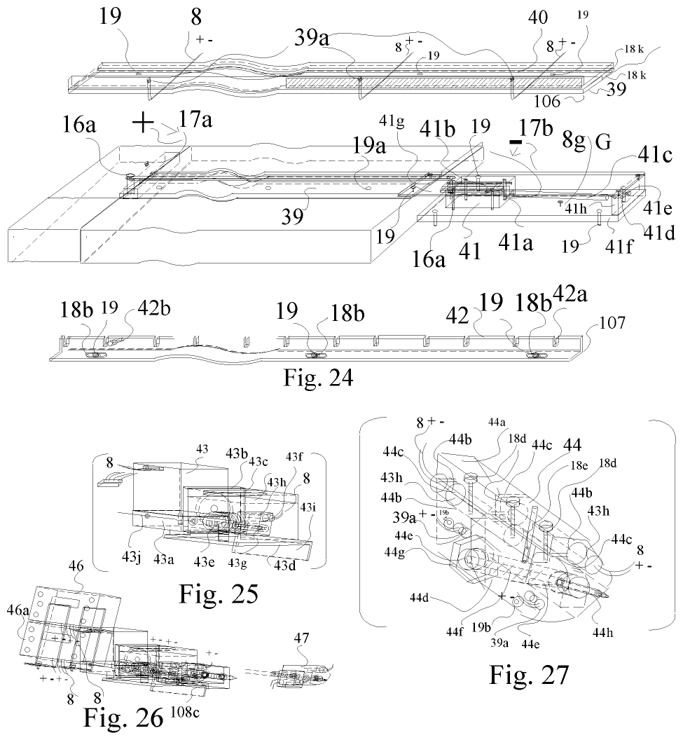

FIG. 24 Showing: System device inline base heating, prior art, On demand extrusion to injection port guide.

FIG. 25 Showing: Purchased items as means to extrude.

FIG. 26 Showing: Named: Extrusion Control System. Attachment of extended heating contoured blocks and power controls that of an extrusion to injection system.

FIG. 27 Showing: Enlarge view: Extended heat system to the extrusion tip and top mold plate heat control.

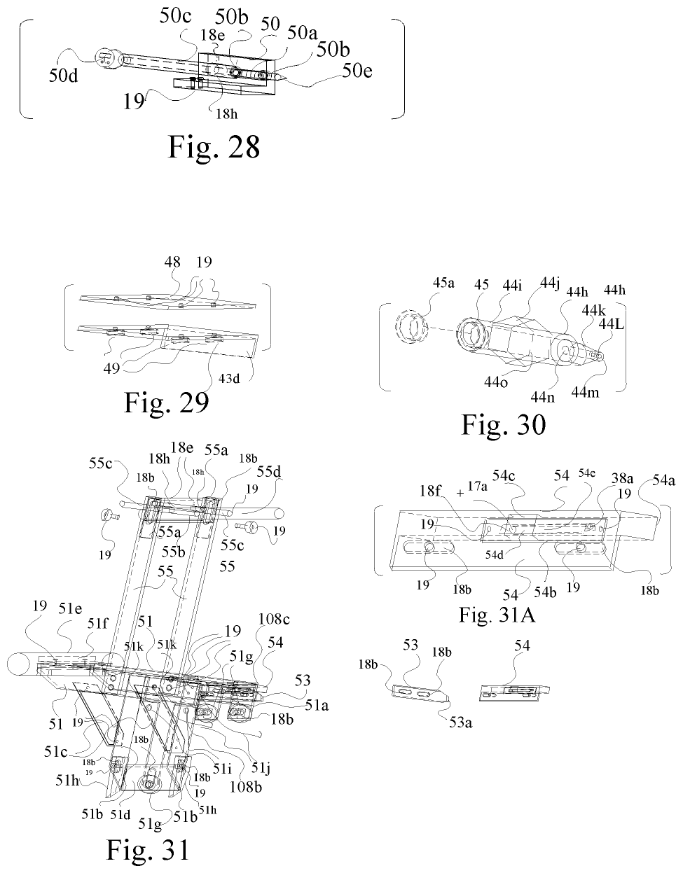

FIG. 28 Showing: Enlarged view means of on demand temperature readings.

FIG. 30 Showing: Enlarged view hot end extrusion tip.

FIG. 31 Showing: Framing structure named Angled Table.

FIG. 31A Showing: Enlarge view of the on demand heat contact points and mount.

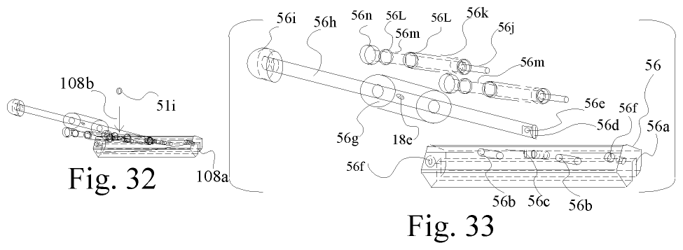

FIG. 32 Showing: Angled Table Guide Assembly.

FIG. 33 Showing: Enlarged view of Angled Table Guide Assembly.

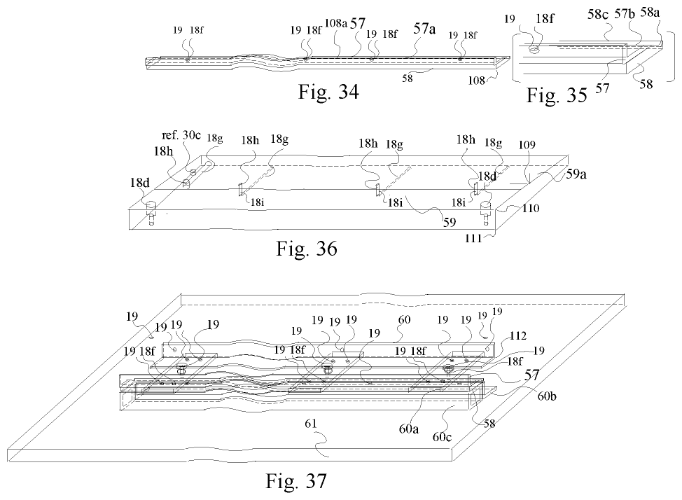

FIG. 34 Showing: Forward angled track assembly

FIG. 35 Showing: Enlarged view of Tracks, forward and rear track are of the same.

FIG. 36 Showing: Prior art base improvements

FIG. 37 Showing: Rear track and its assembly

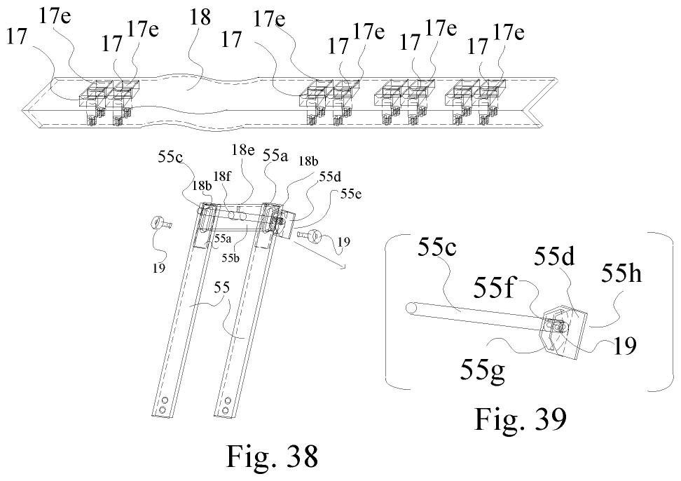

FIG. 38 Showing: Interchangeable switch panel with stacked switches for per injection port molding and attachment.

FIG. 39 Showing: Enlarge view adjustable switch contact extension of stacked switches.

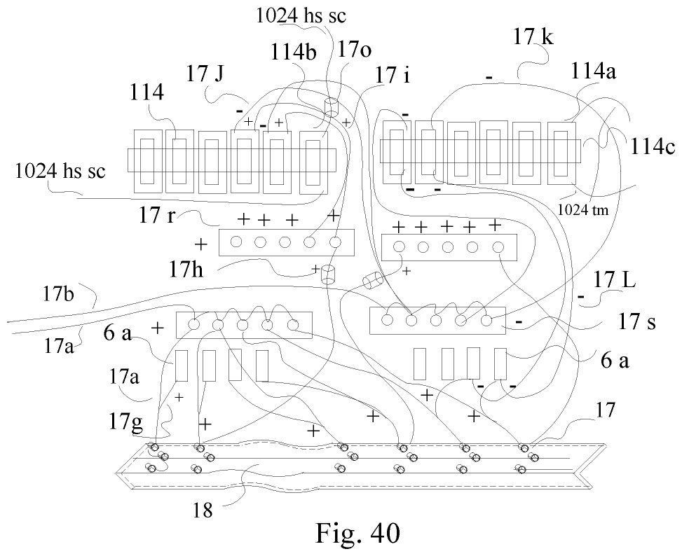

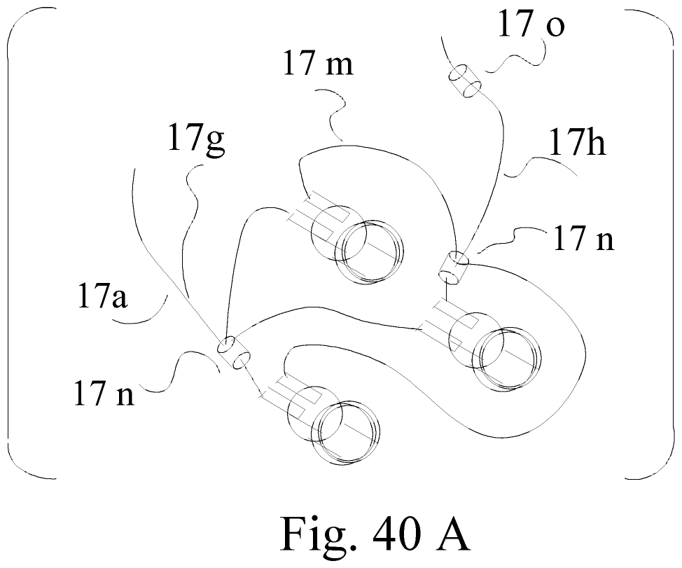

FIG. 40 Showing: A update to FIG. 17 Wiring diagram for vacuum system

FIG. 40 A Showing: Enlarged view of on demand monetary switches

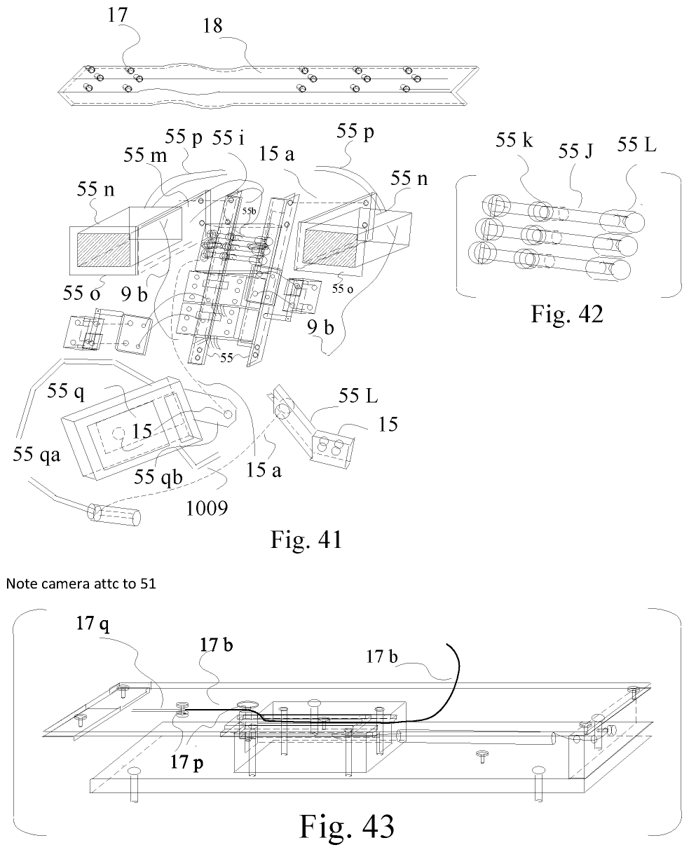

FIG. 41 Showing: A update as an interchangeable switch panel of FIG. 38

FIG. 42 Showing: Enlarged view of adjustable switch contact rods update of FIG. 39

FIG. 43 Showing: A problem solver to FIG. 24 that of a neg friction split of connection

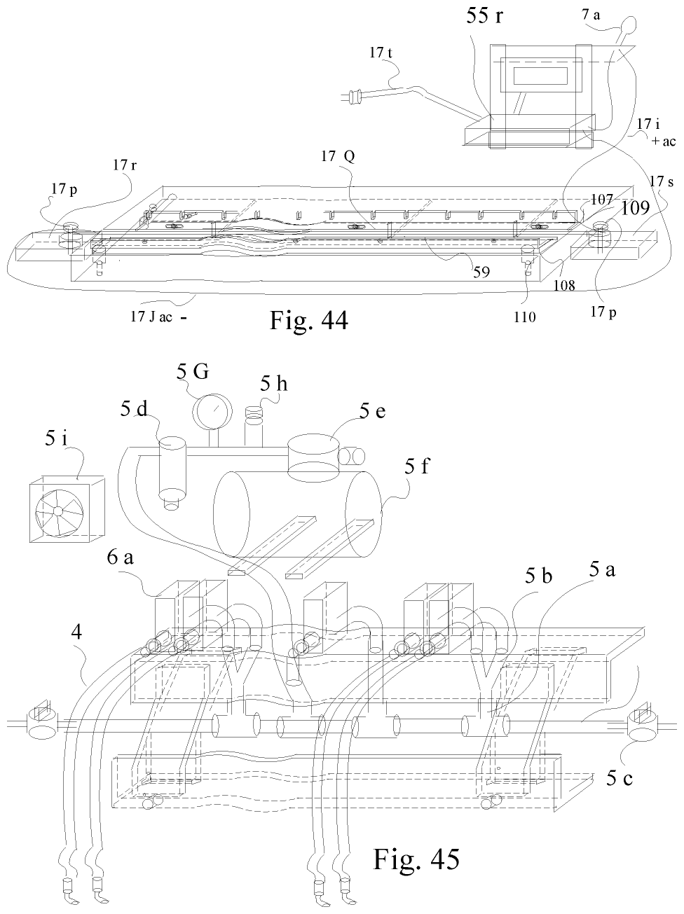

FIG. 44 Showing: Update means to base heat as AC V fast warm, maintain 0.7 Amps

FIG. 45 Showing: Update means of vacuum valves, parts, on separate stand of FIG. 14

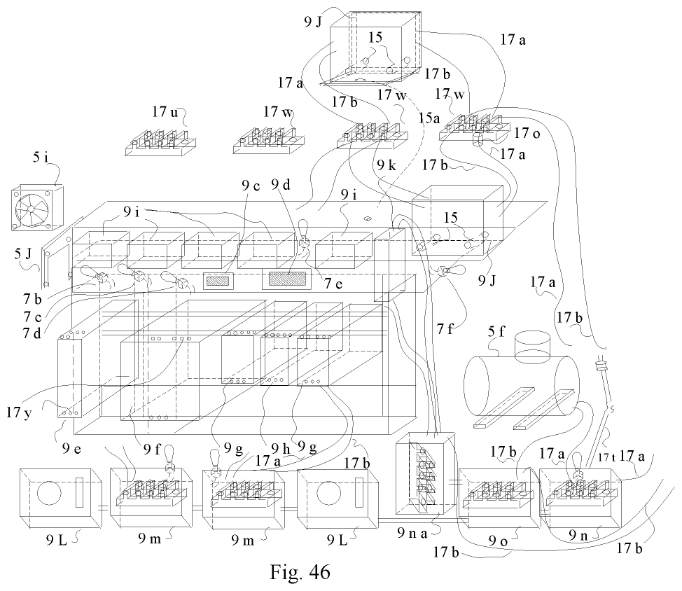

FIG. 46 Showing: Update of power supplies and wiring out of standard or common

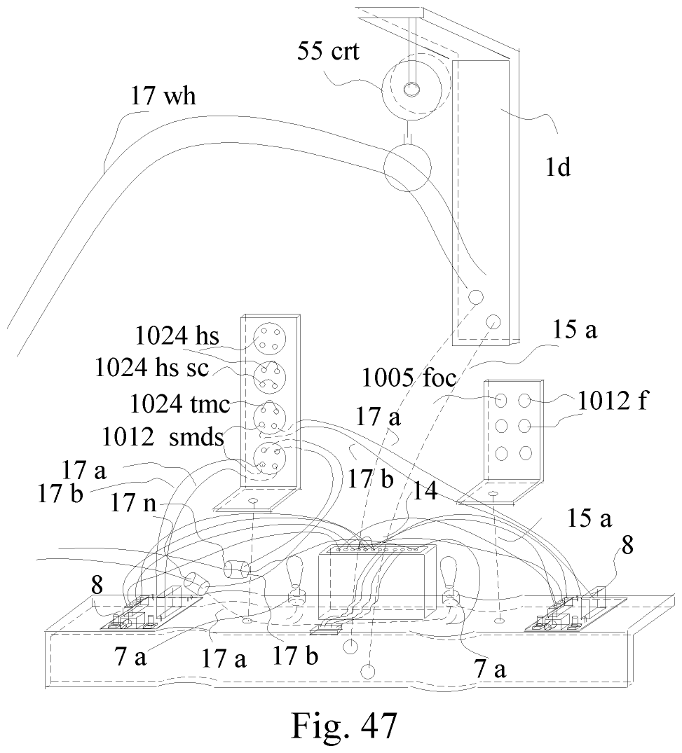

FIG. 47 Showing: Updated version of stepping motor drive system, wiring to Angled Table

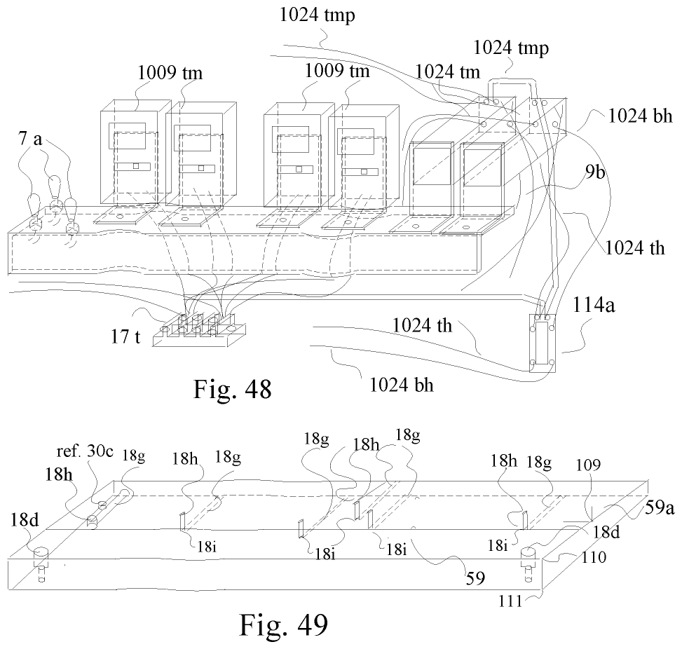

FIG. 48 Showing: Update to FIG. 14 1d as to meters and wiring

FIG. 49 Showing: Corrections to thermal prob locations by scaled comparison of FIG. 36 and means as not limited to an added thermostat prop location,

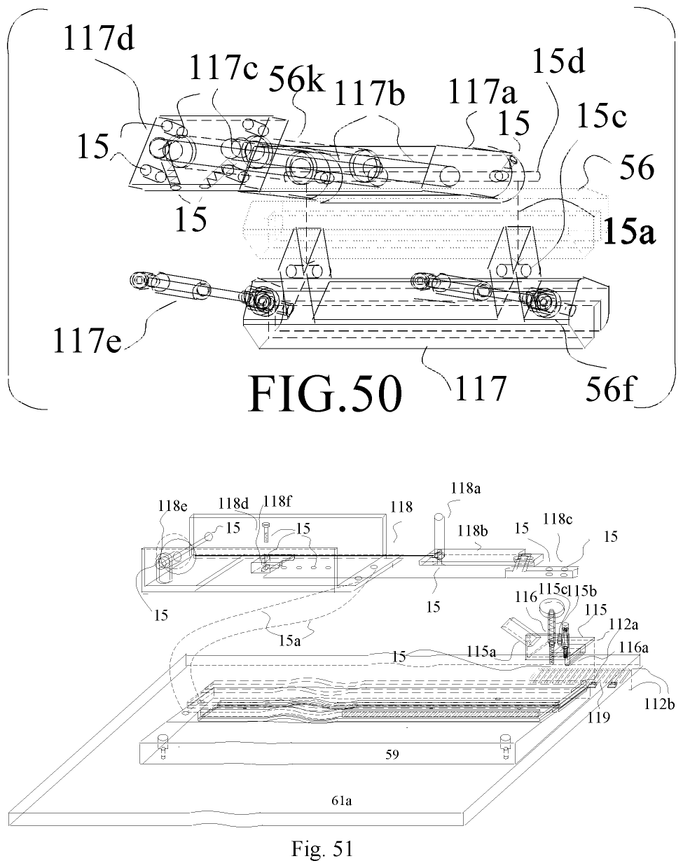

FIG. 50 Showing: An update to FIG. 32 and FIG. 33

FIG. 51 Showing: The means to extract material and parts attached to from mold bottom plate

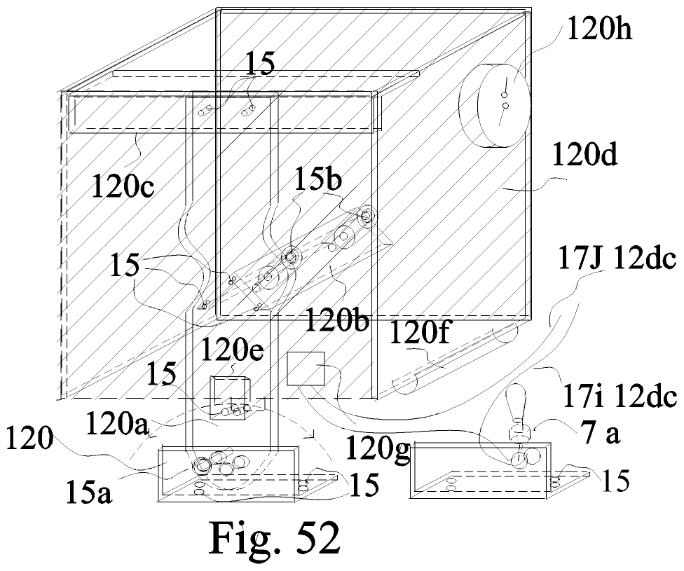

FIG. 52 Showing: Filament spool feed stand, humidity control and warming

FIG. 53 Showing: Spool supply feed

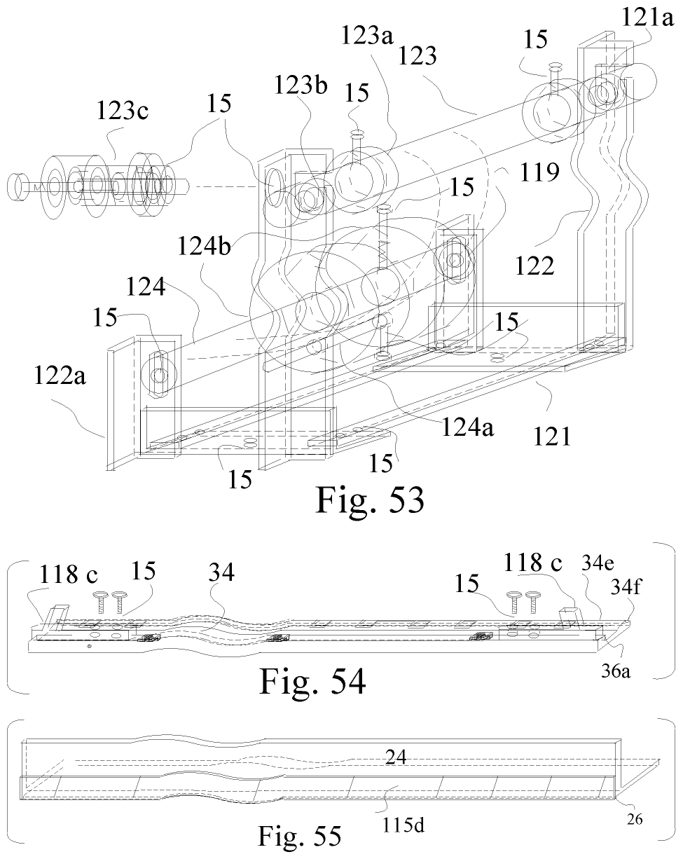

FIG. 54 Showing: Enlarged view of 34 and 34f at described distant end

FIG. 55 Showing: Enlarged view seal of flat 0.025 rubber −0.017 for top mold plate

### DETAILED DESCRIPTION

### Detailed Description

FIG. 14, 1. Installation of device (Machine) system components Angled aluminum base length of system device, 1a. Aluminum support structure assembly, from base to top angle 1b.,1b. Angled aluminum top proportional length of system device, aluminum and its alloys not limited to, 1c.

Power supply mounting brackets, 2. Clearance spacers for mount location to device base, 3. Air vacuum tube connectors to top mold plate 31, connected by means of connector, grommet, bonded, 14a., 4. Connections hose barb plastic tube connector adapter, not limited to, air vacuum tubing to vacuum valve and vacuum connections, 4a. Air vacuum pump or vacuum means, controlling the CFM by means of valves to the desired units, 5. T connection to vacuum supply connection system, 6. DC 12 v mini electric DC solenoid valve normally open, Use Vacuum valve, not limited to, 6a. DC 12 v mini electric DC solenoid valve normally closed, Use Vacuum valve, not limited to, 7. Vacuum valve trigger switch, 7a. Electricity back flow Toggle switch, that of the electric vacuum flow system that of describe below, 8. Electric wiring and of connecting and reconnecting means, 9. AC to DC Power supplies adjustable, for heat control and other means to supply electric, 9a. Digital Panel Meter, Temperature, Mounted as to stacked as to limited space within Fig. drawing and that of not a exact location, not limited to, 9b. Wiring that of to probe or censor and connection, 10. AC to DC power supply, not limited to, 11. DC step up or set down power modular's DC 5-2 v/15-160 v for stepper motor, not limited to, 12. PWM adjustable stepper motor controller signal generator speed regulator that of electric supplied by, 9. Adjustable AC to DC power supply, 9a. Digital Panel Meter, Temperature, Not limited to, 14. TB6600 4A 9-42 V stepper motor driver that of electric supplied by 11 through modules, not limited to, 15. Means to fasten, 16. Means to place, now located to FIG. 40, 18 as when molding process is compete and retraction of FIG. 18, 31 top mold plate improved from 34. improved prior art bottom mold plate by means of 33 and 33a, means to place of 33a of 31 while not in use, other components Filament feed spool or feed means of material that of extrusion, Material to be attached means as to spool or other means on the market, FIG. 15, 17. Trigger switches for on demand vacuum system, wiring FIG. 17, not limited to one patterns or sets, 18. Electrical Switch panel angle bar, interchangeable of different molding locations, 18a. Electrical Switch panel angle bar adjustable attachment, 18b. Means to adjust, 18c. Means to attach, optional wing nut, 24a. Additional attachment panels, 19. Means to attach, 20. Improvement of prior art. Forged Tough 3300 100 lbs. holding capacity straight line push pull with plunger toggle clamp. Not limited to, 21. Improvement of prior art. Material to be attached to clamping means extension as to ease of access to and that of and that of thrust needle roller bearing between 21 means to surface for a more smother tightening Not limited to, 22. Use of prior art attachment angle support, attaching 24a, 23. New angle support, clamp mount, 23a. Angle support clamp distance adjustment blocks, 24. Prior art. Material to be attached to hold by means of clamping, 25. Prior art. New: Material attaching to, elevation and distance to crimping rail thereof and to location of bottom mold plate FIG. 22,34e, 26. Improvement, Material crimping rail to lessening clamping pressure and over flow of material being molded to, railed made by means of milling bottom surface of 24 leaving an 0.025 in depth by 0.030 in width crimping rail not limited to as per material, forward of angle bar upward angle as shown, 26a. Crimping rail and forming of leading edges rounded for attaching material feed in, 27. Added elevation flat bar as to added height that of added heat and size of bottom mold plate. Material steel. Not limited to. Option cooling grooves that of forming heat reduction air flow relief grooves (That of material being attached to) from width surface front to back and depth of 0.07+−0.060+−, wide grooves, forming 0.032+− wide fin the length of the elevation bar, 28. Added elevation flat bars as to added height that of added heat and size of bottom mold plate, Material aluminum. Not limited to, 29. Prior art: Elevation plate, 30. Prior art: Bottom mold plate location pin, 30a. Improvement: Top and bottom mold plate lineament cam Material: Steel. Not limited to, FIG. 15, assembly, 9. That of means to fasten, as to the assembled are all of the assembly of the attachment to the base plate surface and that of the base degree, That of the base surface being the factor of all parts applying to the system process. Whereas as plate 25 holds the parallel of 24 + or − tolerance to mold plates degrees per tightening of clamping system means 21 and its attached part to elevation plates an base, FIG. 16, 30a. location stop cam for top and bottom mold plates location stop, Whereas both plates milled squire as to the leading end while aliened together as to top and bottom mold cavities. Material steel not limited to, 30b. Added clearance as to lift of and the movement of bottom plate forward for part removal from bottom plate, 30c. Extended pin rod to base plate surface and below, 19. Relocated fasten hole and means to fasten, 18e Set screw, FIG. 17, 17 On demand as to manual 7. trigger switch described above to valve, 17e On demand trigger switch as to manual 7a. toggle that of the to the depression of 17e. is the lead to 17f. while 17e. is not pressed being the disconnect location turning off back flow electricity to 17f. 17f. That of a trigger switch to 6. Valve open for checking the valve, feather that of 6. valve open until closed and reopened after use of 17. and 17e. keeping a constant air vacuum that of a more constant temperature derived from the heat source of the device while in use, keeping a better vacuum by unites measurements, 17a. Continues + Lead to each switch that of valves 6 with detachment connection at end of switch panel, 17b.—common to each switch and valves 6. detachment connections, 6a. with detachment connection at end of switch panel, 17c. On pole of 17 to back feed flow switch 17f lead pole, 17d. Lead from on pole 17e to lead pole of 17f whereas 17e is on when pressed. Off when up, 6. Open valve, 6a. Closed valve, 8. Electric wiring and of connecting and reconnecting means. That of a system that of multiple wiring can lead to one switch and valve to insure valves are close while one use is open while not being use a continues vacuum flow through 6. Open valve, that of air temperature maintenance, FIG. 18 31. Prior art top plate, 31c. Added vent vacuum port that of attaching air flow from 31b continuing through 31c for vacuum connection 3, 31d. Front of top plate leading edge angled to matting angled of location and clamping channel of bottom plate 36a, 32. Tapered clamping insert +− flush as to height and thickness of top angle not to protrude back surface of upper angle of FIG. 18 top mold angle plate, 33. Handled rods 3/16+ angled for placement and removal of 31. Material steel and placement not limited to, 33a. Handle bar with length for manual handling. Material high heat plastic, nylon not limited to, 19. Means to attach, FIG. 19, 32a. Tapered edge, 32b. Heat expansion key part of 32, 32c. Heat expansion slot that of mating 32b, 32d. dividing top plate, as to heat control of expansion, as to heat expansion tolerance that top to bottom mold cavities matting tolerances in excess of, 32e. Tapered distant end of clamp plunger head, FIG. 20, 18K. Height heat coating, (Paint, plating) 18j. Height heat rubber coating applied be for paint is completely dried as added bonding, Not limited to, FIG. 21, 31e. Correction of angle of relief to port and tip clearance that of prior art FIG. 7 of improvements to patent No, U.S. Pat. No. 9,884,420 B1 angle of relief and tip clearance to injection port that of a 90 degree, FIG. 22, 34. prior art bottom mold plate, 35. Rectangle mounting means for grounding and moving of bottom plate of on demand heat FIG. 23, 37 and moving to prior art location to remove molded part as to this example the stop from the mold plate, 36, Tapered wedge location and clamping guide whereas the channel 36a. is of a mating taper of 31d that of a snug fit as to a wedge hold down fit as to the clamping of FIG. 15 21 and top plate clamp 20, FIG. 22A, 35a. Cable, 35b. Means to solder not limited to as to connecting cable and ground wire to post, 35c Means of hook and attachment, not limited to as to a connection part point to cable as of means to hook and or pulling as to an example of a latch hook and eye, 35d. Grounding to bottom plate post, Aluminum not limited to, 17b. Ground wire, 8. Electric wiring that of the ground wire FIG. 23 8b-pole that of the and of connecting and reconnecting means, 19. Means to fasten, 18d. Counter sink means to fasten, 18e. Set screw, 42c. Alignment point of FIG. 24, 42b, FIG. 22B 36. tapered wedge, 36b. tapered wedge pocket within 34, 18b. Adjustment slot, 19. Means to fasten, FIG. 23, 37. HS © Polyimide Flexible Heater Kapton Film Heater <200 degree C. Thermo Foil Heater. Not limited to, 34a. Pocket that of the bottom side for heat tape, milled in bottom of bottom mold plate FIG. 22, 34, est. 0.008 in depth around perimeter of heater and clearances for high heat tape to hold heater in place, 34b. Milled in bottom of bottom mold plate to depth of heater thickness plus the est. 0.008 for placement of heater, 34c. Milled clearance for heater wire attachment to heater and wiring to est. 0.065 in depth, 34d. Clearance hole for wire feed to contact housing top of bottom plate, on demand heater primarily use is for larger mold cavities whereas the length of time from the injection port to the attachment is of longer requiring additional heat and not of a continues heat as to limiting the heat to the material being attached to as to damaging materials use, 38. Contact housing for on demand contact that of plate heat, Angled to degree that of a surface to surface contact Material: high heat none conductive as Plastic, carbon fiber or example PTFE and other or to insulating aluminum, 38a. Electrical contacts as to point contact. Not limited to two contacts, 19. Means to fasten, 8a. Lead wire connecting contacts to heater through a means to connect as to insulating and connecting, 8b. − Ground to bottom mold plate as to connection of ground through to 17b. Not limited to, FIG. 24, 39. Inline heating process plate for use in applying heat for injection material flow and to assist in attachment, 39a. Temperature sensors or probes. Not limited to brand type and use for applications, 40. Prior art, Bottom mold plate channeling for location and back and forth slide movement, Improved as described with bottom of high heat plating or none covered with upward angled shorten in height, 18k. High heat paint to 39 top surface and channel, 18K. High heat paint to 40 bottom surface, 19a. Means to fasten flush to surface attachments, 41. Housing for slide expansion of heating wire, 41a. Milled channel with two milled slots each side of the channel upper portion for milled t shape draw housing, 41b. T shape draw housing, 41h, elevation block, 41c. Spring connected to T shape draw housing, 41f. Base of spring expansion system, 41d. Through hole for spring, 41e. Spring means to attach, 41g. Cover for spring expansion system, 8g. Ground for means to keep tension on heating wire while expansion occurs that of heat, 16a. Heat wire connection poles, 17a. + lead wire, 17b. − wire, 42. On demand extrusion to injection port guide slotted, whereas each slot is of a guide that of the extrusion system to injection port, 42a. Guide slot with lead in tapers edges, 42b. Round end location pin lining to mold bottom plate. Material machine cap screw. Not limited to, 19. Means to fasten, 18b. Means to adjust, FIG. 25, 43. Stepper motor. Nema 17, Not limited to, 43a. Filament feeder, 43b. Side fan. This use is to exhaust, 43c. Top fan. Use for intake, 43d. mounting plate, 43e. Extruding heat dissipation block, 43f. Heating element, 43g. extruding tip, 43h. Heating block, 43i. Mounting plate angle removed, 8. Electric wiring and of connecting and reconnecting means, FIG. 26, 46. ZK-PP2K PWM Signal Generator. Not limited to. Use supply time limited power to the PWM and or to the TB6600 as means to control the length of time the motor feeds the filament, 46a. ZK-PP2K PWM Signal Generator. Not limited to. Use supply time limited power to the PWM and or to the TB6600 as means to control the length of time the motor retracts the filament, 47. Extended heat system to the extrusion tip and top mold plate heat control, FIG. 27, 43h. 12V-24 v 40 w ¼-IN/6.35 MM Ceramic Cartridge Heater. Not limited to. temperature controlled by means of the power supplies described, 44. Extended contoured heat block tip management housing, whereas the contoured block milled from round stock of aluminum limiting heat loss from squire edges, fits the shape of the top mold plate and tip alignment with the port supplies heat for extruding to injection and its port, while placement of tip and retraction of tip reducing heat loss to the next port of molded and attachment whereas the plastic to be injected is of heat management that of the heat block 43h. to the extended contorted heat housing to the tip as to part of the equations of heat management is of the amount of molten material from 43h. to the tip, 44L. as to the amount needed and the recovery time that of the speed of injecting for the molten material to reach its attachment at the heat need to attach and or fuse while reduction of heat to the attaching material whereas as an added equation of the described is the end tip ID as to flow and of the diameter of the filament, speed and toque of the motor, its drive, extrusion displacement block, heat block, extended contoured heat block management to a system described as to not limiting to one filament size, or limited plastic types and that of its capable system, 44a. On demand heat and heat loss management, contoured as close to the top plate as to heat control that of the material being attached to by means of managing heat loss, by means of providing preheat to the top mold plate and port lessening degree of heat that of the base heating system reducing the material being attached to overheated for lengths of time. While temperature needed with filament being use that of flow and attachment and or fusing whereas the stable heat temp for the material that of damage as to its surface, flexing that of reducing its use and needed heat temp for the inject is of a adjusted balance for the attachment requirement or requirements, 44b. Cylinder holes locations lower on 44a then of 44 as to the balance of heat use as to heat transfer then of an melting of temperature control, 44c. A system of channels that of the means as to relief of material stress for the fastening of the two heater different locations, 44d. 6 mm threaded hole through. Not limited to, 44e. 44e. Extension of distance thread tube from 43h that of a heat block as a 6 mm OD thread tube that of brass with a through hole side that of to effectively fit a plastic filament. Current 0.078 OD and ID not limited to. That is of a predetermined length to effectively attach the extended contoured heat housing to existing 6 mm threaded ID with in 43 replacing the extrusion tip with the extension tub, 44f. ID that of the filament size tolerances, 44g. 6 mm thin locking nut, whereas replacing the extrusion tip with the extension tub, a means to tighten to hold extended tub in place whereas install described extended contoured heat housing through the threaded ID as to the brass tub predetermined length and securing the Extended contoured heat housing as to its contouring, as to the top mold plate by means of 18e, 44h. 6 mm Tip not limited to installed within described 6 mm threaded ID of described extended contoured heat housing, 39a. Temperature sensors or probes, 8. Electric wiring and of connecting and reconnecting means, 18d. Counter sink means to fasten, FIG. 28, 50. Bracket, 18e. Set screw, 18h. ID Installation through hole, For temperature gage stem, 50a. Spring, Attached over stem in front of bracket, 50b. Means to hold spring while compressing from top plate mold surface to bracket, 50c. Temperature gage stem sleeve. Item of a Tyler cooking Temp meter, 50d. Temperature digital read out, 50e. Point of temperature reading. Reading are guide derived from the average temp needed to effectively mold and attach per application, 19. Means to fasten, FIG. 29, 43d. Original mounting plate shape. Remaining in drawing as to line up of parts, 48. Changes removing front angle and adding 4 threaded fastener locations as to adjustments that of an assemble and of FIG. 26, 47 to injection location. Material Aluminum, 49. Showing slotted adjustments that of the 4 threaded fastener locations what are of top rails of extrusion structure frame, FIG. 30, 44h. Relief diameter 0.175+− not limited to, 44i. 6 mm thread. Not limited to, 44j. Hex as means to install and remove, 44k. Tapered turn for alignment and form a seal to injection port, 44L. Turn est. 0.110 with a short turn est. 0.080 in length and tapering up to relief diameter 44h whereas short turn is within the port limiting remainder of mold material within the injection tapered injection port as to shrinkage and removal. All dimensions not limited to as are all determined on the mold port and its length. Material brass or stainless not limited to, 45. Counter bore for means of a shoulder sleeve bushing/seal, 45a. Shoulder sleeve bushing/seal. Material, aluminum, or high heat plastic material for the means of a seal from the extending tub 44f as to thread and end surface alignments. Not limited as to a softer material is of more flex to aliening to port, FIG. 31, 51. Top angled rails. Materials aluminum. That of a mounting for the attachment of the Extrusion Control System to not limited to as to interchanging different described extrusion control systems as to proportionally sized for enlarged and improved systems as to description. 51a. Front angled aluminum that of wheel attachments and adjustments, 51b. Vertical rails, angled aluminum, 51c. Vertical rails to top angle rails angled structure support plates of aluminum, milled to interlock 51 and 51b, 51d. Cross member plate of Aluminum. For structure strength and wheel attachment and adjustment, 51e. Handle 1.00 in diameter milled as to inserts in to the top rails extending beyond each rail. Material Nylon not limited to, 51f. Milled attachment within handle, 51g. Front and rear wheels. Aluminum with Bearings. Not limited to, 51h. Balance guides, Not limited to width, Nylon not limited to, 51i Threaded holes that of assembly of 56, 56m, 51j. Adjustable spring decompressing tension, as to distance of spring travel cables. Material steel. Not limited to. These cables one on each side of the Angled Table Guide Assembly 56 of 56e hold the slide guide in place with adjustments as to the balance of the angled tabled, 51k. Clearance of inner angle, 18b. Means to adjust, 19. Means to fasten, 53. On demand extrusion to injection port guide. Material carbon fiber not limited to, 18b. Means to adjust, 53a. Leading tip, 54. Mounting bracket for on demand spring steel contact point, that of angled aluminum milled, 55. On demand switch arm, elevation to switch on demand switch panel. Length + or −, 55a. Milled guide channel for 55b, 55b. Adjustable cross member, 18h. ID through hole, 18b. Adjust slot, 18e. Set screws, 19. Means to fasten, 55c. Adjustable to switch location distance rods, 55d. Contact to switches bar, Material high heat plastic, Nylon not limited to, FIG. 31A, 54. Mounting bracket as described, 54a. Bracket forward surface, 54b. Recessed in said forward surface for spring contact switch installation that of per assembled to none conductive base, 54c. Clearance in this case milled for per assembled mounting, wiring of, 54d. Spring steel contact points, 38a. Contact that of contact points, 18f. ID through hole for wire, 18b. Adjust slot, 17a. Plus lead wire, FIG. 32, Angled Table Guide Assembly, FIG. 33, 56., Slide from right to left and forward down compression and compression upward release guide housing. Nylon, Plastic not limited to, 56a. Slide channel that of the forward tapered rail upper angled that of a rail to the channel, 56b. Cylinder holes that of a mating size of end 56j, 56c. Threaded post that of a rectangular end that of a means to tong and groove that to private, 56d. Grooved in the forward end, of the forward position location, of angled table rod lock, 56e. Means to pivot attached by pin steel or machine screw, 56f. Adjustable spring decompressing tension, as to distance of spring travel cables attachments, 56g. Forward position locking in sleeve, whereas the forward downward compression of the angle table guide assembly whereas the sleeve rides within the clearance of FIG. 31, 51b Vertical rails and 51k Clearance of inner angle while angle table is being moved into the downward forward position 56h locking rod drops downward after clearing the forward end of the sleeve surface remaining lock that of manual placement by the nub 56i between inner angels of 51b locking. Release is simple manual by lifting the nub 56i upward until released, 56h. 56h locking rod, 56i. Nub, 56j. Turn forward end that of a piston for cylinder ridge movement, 56k. Compression spring, 56L. Compression spring positioning lock nut and locking nut distance that assembly location FIG. 31, 51i, 56m. ¼ 20 threaded bolt not limited to with turn forward end, 56n. Head of bolt, 18e Adjustment set screw, FIG. 34 Forward angled track assembly, 57. Predetermined angle and guide rail plate, whereas an angle milled on a angle that of the predetermined degree per application as to the degree of the angle table and of it assemble movement side to side and in the direction of the degrees application, 57a. Guide rail aluminum as rail described that of the Table Guide Assembly that of guide channel FIG. 33, 56a, 18f. Fastener alignment holes, 19. Means to fasten, 58. Forward predetermined angle plate, milled on an angle that of the predetermined degree per application as to the degree of the angle table and of it assemble movement side to side and in the direction of the degrees application. Not limited to as material and 57 and 58 as one part, FIG. 35, 57b. Degree angle that of described, 58a. Degree angle that of described, 58c. Forward angle degree edge, FIG. 36, Prior art base improvements, 59. Prior art base, 59a. Newly determined angled heat transfer deflection, whereas the angle becomes an added measure to heat transfer to the material being attached to as to the common knowledge of heat rising, 18d. Counter sink attachment, 18g. Wire channel, 18h. ID installation through hole, 18i. High heat silicon sealant for placement. Not limited to, 30c. Ref FIG. 16 30c, as described, FIG. 37, Rear track same as FIG. 34 and its assembly, 60. Aluminum angle bar attachment to base, 60a. Three cross member plates attaching 60 to 60b, 60c. One inch squire aluminum tubing as reference to elevation and distance from attachment. All tract length are 4 ft. in length as to the base and work molding and material attachment being 3 ft. with other parts extending beyond as to use of, 61. Device plate form that of ¾×18″×6′8″. Not limited to, 18f. Fastener alignment holes, 19. Means to fasten, FIG. 38 Interchangeable switch panel with stacked switches for per injection port molding and attachment, 18. Electrical Switch panel angle bar, interchangeable of different molding locations, 17 and 17e are of the same wiring described whereas to an per injection port molding and attachment whereas valves described above and can be multiple to one set or one (1) per set. As per set as to distance required to size of switch or of a switch assembly, 55. Same as described above whereas 55c is of one (1) instead of (2) two and the removal of 55d, FIG. 39, 55c. Adjustable to switch location distance rod, 55d. Angel contact housing, 55f. and 55g. means to articulate by channel to rectangle end to rod with pin or fasten, 55h. Pad adhered to forward contact housing. Felt. Not limited to, materials to be of the extrusion as described above, Filament as to 1.75 mm ABS/PLA and there different types and additives, not limited to 1.75 mm, not limited to filament, system as to extrusion and molding described above that of proportional sizes that of extrusion that of additional types of material being extruded as, HDPE, Acrylic, carbon fiber not limited to and additives,

Further: Assembly of drawings marker points, FIG. 14 (1) marker point 100 to FIG. 15 (2) 101, FIG. 15 102 to FIG. 18, 103, FIG. 18 103 to FIG. 22, 104, FIG. 22 104 to FIG. 24, 40, marker point 105, FIG. 24, 40, marker 106 to FIG. 24, 42, marker point 107, FIG. 24, 42, marker point 107 to FIG. 34, 108, FIGS. 24, 106 and 107 to FIG. 36, 109, FIG. 34 108 to FIG. 36 110, FIG. 36, 111 to FIG. 37 112, Extrusion to injection assembly, whereas the results are of a productive smaller scaled system that of heat management, on demand heat and air flow that of vacuum to that of placement the material being attached to, securing the said material and that of the mold plates, whereas extrusion system rides on the track with lining up the guide to the table guide pressing the extrusion system downward that of the tip to port, locking in the locking rod and pressing the on to the motor and its feeder manually or ZK-PP2K PWM Signal Generator for extrusion and extrusion filament retraction producing the part and attachment, release of locking rod on to next, that of a machine of lower cost and of extrusion to injection molding system by means of heat management, on demand heat, heat flow and that of vacuum that of described extrusion system described above, that of flex material as to example elastic belting, that of lesser, equal or greater to melting points than that of the material being extruded for attachment,

Further, improvements: A machine for filament extrusion and extrusion filament retraction producing part or parts and attachment to that of flexible material as to belting FIG. 40, 18 Electrical Switch panel angle bar, interchangeable 17a of FIG. 40, 12 dc v lead to switch, 17a lead wire 6a vacuum valve representing (Note currently 41 not limited to + or −) all, 17h+ diode wire from monetary switch 17 to 17r connection junction tremaril, 17i + wire from 17r to 114 relay socket and relay + connection, 17J − wire from 17s − connection junction to 114 relay socket − connection, 17k from 17s to 114 relay pin, 17L from − valve wire to 114 relay pin connection, 114a relay socket and relay for thermostat tip housing heat, 1024 tm thermostat meter wiring to, relay through for 24 dc v thermal monitor wiring, 114b relay socket and relay for heat system supper charge heat to tip housing, 1024 hs sc heat system super charger wire, to relay through for adjustable 24 dc v+ or − heat system supper charge wiring, wiring that of 114 relay socket, and relay described above is that of the same wiring to that of each whereas 114 is of common wiring to use of a relay to that of the use to send power that of 110 ac v through to a 9k time delay to that of a 5f vacuum pump to the depressing of monetary switch 17, opening inline to port valve, 9k time delay for placement of tip in port and heat management of filament high heat in tip to turning on the vacuum to port mold cavity, also with larger heat needed and with the delay as heat time for reduction of air and filament burning within the flow tub of 44h tip,

Further, improvements: FIG. 41, 18. Electrical Switch panel angle bar, interchangeable updated to a more direct means per port, with 17, on demand momentary trigger switch, (FIG. 40 A, whereas three switches are connected to one 17, and its system of process as described), switches are of rows in this case representing the three different sizes of a product as each row is of a set size to each port being molded with each row offset to the different location of size as to length to each port to in line with 44h tip and 13 of FIG. 21, or prior art injection port or ports, FIG. 31, Angled Table as to assembled parts that of a frame for FIG. 26, Extrusion Control System to whereas 55b. Adjustable cross member attached to 55. On demand switch arms is updated to three,

Further, improvements: FIG. 42, 55J threaded bolts comprising of a threaded bolt with a means to thread in and out, 55k locking nut, 55L compressing or striking tip to 17 on demand momentary trigger switch, further means to closer visual thermal monitoring to tip locations, by mounting on 55 on demand switch arms two (2) 55n monitors by means of assembly marker line 15a, 15, means to fasten to 55m mounting brackets, within 55o panel plates, with 55p 24 dc v wiring, to power connections, 17 whesh sheeting, connection as described and drawn to the power supply or supplies selected to perform within the voltage and amperage required. 9b thermal prob from 55n left side shown to 43h heat block 1, right side to 44. Extended contoured heat block 2 tip management housing, 55Q fiberoptic monitor and camera use is for visual of 44, and 44h during extrusion to injection molding keeping site on tip to port, material movement, possible build up, plugging, over heating of material as to high temperature with more air then needed can possible burn the filament or displacement as to volume to density of material being extruded to volume needed to fill the mold cavity, 55Qa fiber optic and camera mounting with 55Qb mounting bracket to 55b, 15 with camera 55Qa mounting to 55L with 55L bracket mounted to 51,

Further, improvements: FIG. 43, that of a balance of current friction whereas developing a means to supply heat under dc voltage, with over coming energy supply issues to complete melting of the − side of FIG. 24, 16a now FIG. 43, 17b pole 17p sold connections poles to whereas finding the − pole was often double the temperature of the + pole whereas the − pole melting while achieving a means of voltage to current needed for the melting flow balance within the cavity while staying in a goal to run the machine on dc v of solar or wind as alternative energy as well as operating chances of shock safety, to compensated with the division of the friction from one pole to another 17p sold connection pole, that of FIG. 24, 41b T shape draw housing is now made from Red Bakelite flat stock as to not limited to, to reduce shorting and connection of 17b on top and with the division as a extended wire of the same size as 17b − in wire, to approximately 1 inch (2 inch with eye connectors) to another sold connection 17p from extended to 17q resistance heating wire, the heat was lowered of the − lead in wire pole and of the pole connection to restrictive wire, within a safe heat and balance that of − to the + with achieving the heat needed while heating with dc v and with converting from ac it is 3 amps ac to est. 12.5 amps dc needed for heat achieved, other as current power supplies system as high as 14 amps within a 24-26 dc v's not limited to, is well within allowable temperatures, further that of description of heat balance A division of neQ. − direct current voltage comprising of that of two (2) sold connection poles comprising of machine screws, nuts, washers, AWG wire that of equal size to that of neQ. − lead in wire and other wire that of an estimated 1 inch long, Wherein connection of the said − lead wire and said 1 inch wire to a said sold pole with the distant end of said 1 inch wire none connected, connecting said distant end of 1 inch wire and to said current use that of restrictive, balances the current friction developing heat of that of the two (2) poles reducing the volume of heat that of a − lead wire to one (1) connection to within a fair heat range of the + pole that of the use,

Further, improvements: FIG. 44, was added to the system of means to heat the base and over all warming up, to the strive to be dc powered as a warm up system as dc power to the design of the machine was taking to long to heat to desired heat and needed a faster warming, to surprise while ordering different restrictive wire for the dc heat, built the 110 ac warm up and now also maintain as to limited safety issues as will heat to close to needed heat range without high amperage that can be fused or circuit breaker at less than 8 amps well within operator safety, whereas 17r connection junction terminal and 17s poles connection terminals of—material not limited to, 17p poles, 17J of ac v and 17i ac v to 7a on off toggle to 55r 110 heat controller, designed for stove heating elements 17t 110 ac power cord feeding power to 17Q coiled restrictive wire operating at 0.75 110 ac v and 0.75 amps delivering ampul heat of 145 degrees + or − to the working area,

Further, improvements: FIG. 45, Upgrade to means to vacuum system not limited to whereas vacuum pump that of low amperage 110 ac v 1.7 A optional 24 dc v vacuum pump and a relay system that of 12 dc v and multiple system of upgrade electric 12 v dc vacuum air valves as described, further, FIG. 45, is of a updated in the means that of the vacuum system whereas 6 a normally closed valve is a more industrial air valve that of 41 6a's mounted on 1d separate mounting structure as described with 1-1b located as similar to and lower of FIG. 14, between FIG. 14, and FIG. 15, whereas each valve with the exception of a center that is of a warming air flow valve, is plumbed with 4 air flow tubing and secured with tubing clamp, tub mold port couplings and sealed to each 13. Injection tapered port to where 5f vacuum pump is wired to a system of power supply, relays and time delay as well as 6a normally closed valve whereas as a result of pressing a 17 on demand momentary trigger switch powers the opening of the valve, vacuum pump with the air flow running through a system 4. Air flow tubing, 5ba-5b air flow fittings and connection, (5c open and close air flow valve for air warming.) to device that of 5d air flow filter, 5g vacuum pressure gage, 5h vacuum release valve to 5e pump intake, 5i alternate air flow cooling fan, with pump mounted to FIG. 37, 61,

Further, improvements: FIG. 46, is a industrial in most system of suppling power to the different parts of the machine requiring power that of on the market components and material to make components, it is mounted to the back left corner and that of a mounting structure with DIN mounting plates of the 61 base consisting of power supplied to of ac at this time and not limited to the dc as described from the right to left of starting in front of structure of FIG. 46, 9n ac power in box and to the vacuum pump 17a Continues or + Lead and that of a on off toggle mounted in the back of the box, to 90 and through as 110 power however 90 is of the 17b that of the on demand system to the terminals and relays, 9n a is a division of a 100+− of wire used to wire the on demand system of the vacuum pump est. 50% of wires through the means of a 7a toggle switch off one side and turning on another with common means as of ac power supplied to whereas 17a is the common operating the 9k 110 time delay from both sides continuing 110 power to 9L alternate switch and plug in, continuing to 9m power terminal box to whereas through a 7a toggle switch powers the lower amperage power supplies 110 ac v in to 24, 12 dc v out and next 9m power terminal box to whereas through a 7a toggle switch powers powering the higher amperage ac to dc out power supply to 9L alternate switch and plug in each 9m wiring is directly through the terminal of the box to a power supply 9f 24+− dc v out 40 amps 9g 24 dc v 5 amps, 9n 12 dc v 5 amps with the 9e 24 dc v out direct out as not of the toggle and going to 17u 110 ac thermal that of alternate 110 future supply to 9e and on off by means of a 7b on off toggle switch to witch 9e powers the thermostat meters with the toggle switch allows the turning off or on of the power being supplied by the relay without off or on to the relay power, other power supply described run directly or through the means of a switch to means of suppling energy to a component or wired to a 17w thermal, of its voltage for dividing up to multiple componence with in the suppliers amperage, switches as 7c on and off of tip heat super charter system, 7d on off to as supplied from in front of described 17t 110 ac power cord going to 9c amperage meter, 9d being a dc voltage and amp meter, 7e 24 on off dc v toggle switch for 9i step down dc v suppliers, 5i 12 or 24 dc v fan attached to 5J with means to draw heat away from the converters, 7e allows the intermittently turning off or on to four (4) of 9i not limited to, that of voltage and amps to the extruding injection system heating elements, all componence described are wire as to the instruction supplied by the manufacture and are common of its system of use and to be connected as to use, with the exception of 9i DC Buck Converter, “DROK” DC to DC Step Down Power Supply Module 10V-56V to 0-60V 0-12 Adjustable Voltage” and not limited to, with the approach of running on dc v's with the challenges of powering a 3 ft. +− heating element with 24 dc v +− to achieve heat needed could not find converters within the dc v and amperage as one unite with 12 amps just not doing the job as one unite, resolve went to two DC Buck Converter, “DROK” DC to DC Step Down Power Supply Module 10V-56V to 0-60V 0-12 Adjustable Voltage” by the means of supplying power to one onto a 17w terminal that of a 17o diode of 17a + lead to the second that of the 17o, 17a and completing with connecting 17b − wire when powered divided the amperage up from both down steppers (Simple description as to feed power to a terminal from power supply, feeding supplied to the steppers, diode to one + lead out from the stepper to a terminal an a − of the out to that of the same out to the second to the terminal less diode and from the terminal to the + and − feeds to heating) described one running 6-7 amps the other 7-8 back and forth example could achieve ample amperage up to 14+ combined amps at the power supply voltage of 24-26 DC V and running cooler then with on at 12.8 amps needed, equating current usage for 3 amps 110 ac to 12.8 amps dc total amps per amp hour only 3, 7f on off 24 dc v toggle switch to that the two (9J) converters,

Further, improvements: FIG. 47, that of 1b. Angled aluminum top and the attachments to that of 14 “DaFuRui TB6600 Stepper Motor Driver, 4A 9-42V TB6600 32 Subdivision for Nema 17/23 Stepper Motor Driver CNC Controller Single Axes Hybrid Stepper Motor,” not limited to, two (2) as one (1) to forward drive of the stepping motor and of two (2) reverse drive of the stepping motor 12 “DC 5-12V/15-160V Stepper Motor Drive PWM Adjustable Stepper Motor Controller Signal Generator Speed Regulator”, Not limited to, power is supplied to 12 and 14 through means of the power supply described above an through 17n splice connections with 14 wired to 7a on of toggle switch to turn off power to the stepping motor while setting 46. ZK-PP2K PWM Signal Generator, not limited to, 1d bracket mounted to 1b, 55crt wiring harness retraction device, 17 wh wiring harness whereas connection brackets house panel type connection for connecting or disconnecting wiring harness to angle table and it assembly, 1024 heat system connections to angle table assembly, 1024 hs sc tip heat super charger that of spliced into 8, of 43h, 1024 tmc thermal meters connection, 1012 smds stepping motor drive system that drive the filament into the extruder system, 12 dc v power to two (2) 46. ZK-PP2K PWM Signal Generator, and back out through the set times of drive of 46. ZK-PP2K PWM Signal Generator through the means of 55r arm switches to each a forward and the reverse powering of the stepping motor at there set times controlling the amount of filament material in and out of the tip as to controlling drippage and filament volume heat to that of less volume as to density increasing melting of the filament that translates thinner melted material that can travel into a mold cavity at a greater speed at the start and with a push of the larger volume coming through equates to a less heat needed at the base to insure the travel to, with this process of a system is dialed in to, the time (distance of retraction) and with the time delay to vacuum supplied to the port, and of 43f block 1, heat being of less temperature of tip and its housing, being a constant melt flow volume to extrusion injection while drawing the molted filament material through the vacuum system described, equating to less heat to the material being attached to while the machine as a hole (Stationary or of Portable size.) is operating at less the 8 amps current supplied. FIG. 47, 7a on off toggle switch to the left turns on or off center none plumb valve and starts the vacuum pump as to vacuum air warming, 1005 5 dc v fiber optic camera panel connection, 1012 f, 12 dc v fans panel connections

Further, improvements: FIG. 48, FIG. 14, whereas 1009 tm 9 dc v thermal metering to various locations of the base shown in FIG. 49, 18h. ID Installation through hole for temperature gage stem or thermal prob, supplied power through 17t thermal, with 1024 tm thermostat meter, thermosetting temperature to current through 1024 bh 24 dc v base heat, 114a 24 dc v relay, 1024 th 24 dc v tip heat relay, and there 9b. Wiring that of to probe or censor and connection whereas as 1024 bh 24 dc v base heat prob is center of described and 1024 th 24 dc v tip heat, 114a 24 dc v relay, FIG. 27, 39a. Temperature sensors or probes and location, not limited to, further that of described thermostat meter and system also applies to that of the heat block 1, supplied power by means of power supply described as to extension of heat control that of less adjustments, that of starting of machine, room temperature changes, whereas current heat to 43g, extruding tip, can exceed 635 degrees to what reflexes the block heat 1 and filament drive (Push), further information,

Further, improvements: FIG. 49, Corrections to thermal prob locations by scaled comparison of FIG. 36, and means as not limited to an added thermostat prop location,

Further, improvements: FIG. 50, whereas FIG. 33, 56 is made to except hinged part 117a guide rods cylinder housing, 117b cylinders, through means of 15d hinge pin or pins that of 15a assembly to line, 117c grind rods to cylinders, 56k springs, 117d mounting plate, 56f slotted adjustable attachment parts for 117e small shock absorbers replacement of wire described, whereas the shock absorbers dampers and adjusted to the length of extended, with 56k springs pushing to length of an compress to extrusion injection when compressed, 15 means to fasten,

Further, improvements: FIG. 51, that of an extension of 61, 61a, platform 59 base, and FIG. 15, 26,27,28,29, FIG. 24, 40, in the slide movement of FIG. 22, 34 with FIG. 22, 35 Rectangle mounting means for and moving of bottom mold plate, now FIG. 51, 118c rectangle with angled stub that of a hooking means, that of 118b extended arm that of attaching to 118c, 118a that of a handle to attach with and to move as needed, as 118a retracting cable means is slightly greater in tension to that of the opposite means to pull or retract, end to whereas pulling 34 from molding location through the means of 118 retraction cable to 118c mounted to 118d retraction mount with elevation adjustment, 15a assemble line 15 means to fasten, attachment to base, with 118f, 34, prior art bottom mold plate up dated, shoe as to when retracting, bottom mold plated is shoed in to the shoe as to not lift when removing the material and attached parts from the bottom mold plate, (Materials to make described is of aluminum, plastic, nylon, not limited to other then material use to strength, durable, and heat requirements of it location, further current 118e is of a key as in key chine retraction device, not limited to, whereas as described is of the other end FIG. 54, 118c whereas 118e of lesser tension with requiring as needed movement as to 118a described while retracting 34 back to its molding location, further of that described assembly 115 angle aluminum not limited to, mounted to extended base 59 and of the elevation parts shown as to FIG. 15, 26,27,28,29, FIG. 24, 40 to that of the same elevation to allow movement and guidance, mounted with 115b consisting of a threaded rod with nob with a spring over threaded rod to said base through 115 of a larger hole and tightened to a tension desired as to hold down, with 115c alinement pin, 116 material spring adjustable hold foot, 116a barbed surface to that of a grip of material, that of location being described and that of forward to molding feed for means to stretch 119 material being attached to holed in stretched form while clamping through means of FIG. 15, 21, 112a and 112b showing the none drawn location, when releasing 34 from its locking location FIG. 16, 30a. location stop cam, 30c. Extended pin rod to base plate surface and below by means of lifting 30a and 30c up and out of the way for clearance of 34 to move under by means of holding up as to FIG. 16, pin to housing or prior art, pushing 115a arm out ward and releasing grip of 116a to material, retraction of 118e and hand grip of material being attach to pulling said material while 115a arm has released material for movement, (Note 115a release arm can be held and or done by hand or mechanical fastener example hook and eye) while retracting the material and 34 to 118f shoe and pulling the 119 material being attached to, upward to remove the molded parts from the mold, 34 then can be moved back to molding location by means described and releasing 115a arm it re-holds the material in place for next molding process, being of a manual and mechanical process adjustment of material being attached to, as required,

Further, improvements: FIG. 52, Filament spool feed stand, humidity control and warming that of filaments, comprising of, 120 base of swivel spool feed stand, 120a stand arm, 15 means to fasten, 15d pin 120b spool arm, 15, 15b spool side rollers, 120c angle bar (Material plastic, nylon, not limited to, 15, 120d 4 sides and a top heat container, with means to 15 means to fasten, weld or mold 120e 120d container hold, Materials, aluminum, not limited to, 120f filament guide round bar, 120a 12 dc v heating element. 7a toggle switch, mounted to support mount stand or power supply paneling, 17i 12 dc and 17i 12 dc dc v supply wiring from power supply that of direct to 12 dc v or step down converter for temperature control, not limited to, 120 h temperature and humidity gage, as described keep the humidity down from absorbance to filaments with absorbent properties reducing the burning due to absorb moisture,

Further, improvements: FIG. 53, spool supply feed frame comprising angle and flat stock aluminum not limited to, angle braces for length, 121 flat stock for spooling width, 122 spooling height, comprising of 121a spool rod slot, 123 spool rod, 123a spool rod collars, 123b spool rod grooves that of diameter of 121a, 123c adjustable pressure tension pin and its assembly comprising of adjusting machine thread screw for spring tension adjustment, housing for said screw, housing to pin sleeve for pin diameter bore and counter bore stop for two diameter pin, with a spring within the counter bore and pin counter bore diameter to pin diameter within the sleeve, making of adjustable tension drag for 123a spool rod, 122a adjustable height for 119, guide means, comprising of 124 rod, 124a guide adjustable location and width collars, 124a adjustable width 119 guide to that of keeping the 119 material being attached to contained and free for movement with 124a 15 one 124a collar and width depending on distance of other 124a and the length of 124a, to adjustment within the length of rod 124, end results a 119, spool feed system with height to guide difference to effectively feed 119 to guide from each end and in-between while drag to slack occurring for spool when pulled for use,

Further, improvements: FIGS. 54, 34 and 34f at described above distant ends, further all ac v thermals are covered, coated and or limited to the device and relay connection,

Further, improvements: FIG. 55, 115d Seal of flat 0.025 rubber −0.017 and its adhesive as to seal the length of 24 for the means of vacuum air flow seal to top mold plate vertical of angle and it air flow design described.

Further, means to make, build described above through means of supplied on the market that of metal, aluminum, of their groups, plastic, plastic groups, in its sold form, means to machine, means to cast, mold or print of parts to be assembled that of means to fasten, by means of bolts, machine screws, washers, lock washer, taping of to fasten, rivets, weld, braze, solder, wiring and means to connect,

Further that of making or applying holes within 119 material being attached to, to that of within the attachment points of the mold cavity of the bottom mold plate, made from copper that of a %. +− rod the fits into a common solder iron that of a length est. 3 inches with a head that of a stamp type with two mill in post that of 0.030+− squire to a predetermined width that of the size of part being attached, that of more than one, as to different size being molded to that of flow through as currently applying the holes while material is in the machine and to in-line with cavity and attachment on 34e, material crimping rail, 119 and designed attachment means, by means of heat until 119 can be made of said hole prior to machine process,

### Current and General List of Materials and Componence: Not Limited to

Further: Materials that of structure, plates and fasteners are of aluminum, steel, plastics, nylon and there alloys and additives, wiring that of the length needed as to application that of copper, steel, heat insulated, AWG wire and not limited to, further: Air flow by means of vacuum is of a finding of to theory that heat flows to heat as when metal working to heat one end of a steel bar and to cool that end the distant end that was not heated is hot as to the cooling of the heated end that the heat is transferred to or runs to the cooler end. As this translates that of the air flow that of heated to unit of vacuum resulting in a lower constant temperature to achieve molding and that of its attachment,

Further: improvements: Wire sheeting: 1 mm-25 mm Colorful Silicone Fiberglass Sleeving Heat Resistant Wire Cord Tube, White Heat Resistant Glass Fibre Cable Sleeving 1-50 mm Temperature Wire 600°. Not limited to, Heat Resistant Insulation Polyimide Film Tape 30 Meters Length×48 mm Width, Heaters: 12V or 24V 40 W ¼-in/6.35 mm Ceramic Cartridge Heater, HS®Polyimide Flexible Heater Kapton Film Heater <200° C. 6×20 mm 24V 70 W Ceramic Cartridge Heater Cartridge Heater Green High Power 24V 50/65 W, Tip housing extension: Brass M5 M6 M8 Full Threaded Stub Screws Double end Connect Screws Studding's, Seals: 10 Pcs 8 mm×2 mm Rubber O-ring Oil Seal Sealing Ring Gaskets Red, Black Heat Resistant Thin Silicone Grade Rubber Gasket Sheet 12 by 12, High-temperature Resistant Silicone O-Seal Ring Gasket Kit Rubber Flat Washers, High temp. silicon, Cooling fans: For Ender 3 5 Pro Quiet Silent Hot End Cooling Fan 40 mm 4010 3D Printer 24V US, 24V DC 60 mm Cooling Fan 60×60×10 mm (2.4×2.4×0.4 in) for CPU PC Printer Laser, Quiet Silent Hot End Cooling Fan 40 mm 4010 3D Printer 24V US, Air flow lines: 2 mm-14 mm ID. Food Grade Silicone Flexible Tubing High Temp Hose Soft Rubber Pipe. Airflow connectors: 10 Pcs 3/16″ 5 mm Fuel Line Hose Spring Clips Water Pipe Air Tube Clamps, Polyethylene HDPE T—Fitting ⅛ and ¼″ OD, Barbed, Pack of 10, Air flow extender connections: 10 Nylon Straight Connector Hose Adapter Vacuum ⅛″, Air flow valves: ⅛″ Inch Fast Response Electric Air Water Solenoid Valve DC 12V Normally Closed, Filaments: Filament Black 1KQ 1.75 mm ABS, Nylon Filament PCTPE Copolymer 1.75 (Black), PCTPE Black 1.75, TPU 1.75 (Black) mostly used, Aluminum: 6061 Aluminum Square Bar, ¾″ Square×12″ long, Solid Stock, T6511, other purchased in local hardware stores,

Brass Tip design materials: 360 Brass Hex Bar, Unpolished (Mill) Finish, Extruded, H02 Temper, ASTM B16, 0.25″ Across Flats, 12″ Length, Pieces 5/16″ C360 Brass HEX BAR 8″ Long New Lathe Bar Stock 0.312″ ½ Hard Industrial Metal DE-0034DU, Copper: Pure Copper Round Rod ½″ Dia. 8″ Length Bare Copper Cu Metal Rod, Friction Reduction material and guiding: “BuyPlastic” Natural White HDPE Plastic Sheet ½″ Thick, Size 6″×12″, High Density Polyethylene Board, Actual Dimensions 5.75″×11.75″. Electrical heat controllers using 110-120 AC v:

10000 W SCR Digital Voltage Regulator, AC 220V 80 A Electrical Motor Speed Controller Regulator, High Power Voltage Regulator Dimming Thermostat, SCR Electric Voltage Regulator Dimmer Temperature Controller Motor Speed Controlling Module Board with Cooling Fan (110V AC 4000 W)

Electronic controllers for stepping motor drive: Cycle Delay Drive Module, PEMENOL 3.3-30V 8 A Dual Mode High Power PWM Dimming Motor Speed Controller, LCD “Pulse” Frequency Duty Cycle Adjustable Signal Generator,

Resistance wire tried and some using: Chromium Resistance Wire, 1000 ft Reel, 32 Gauge SWG-33/34 AWG-0.0108″ Dia. Chromium Resistance Wire, 1000 ft Reel, 32 Gauge SWG-33/34 AWG-0.0108″ Dia., Nichrome 60 Resistance Wire 100 ft spool-32 Gauge, Nichrome 60 ribbon (flat) wire 1/16″×0.0063″, 1.420 ohms/ft, 10 ft spool, 1.6 mm AWG14 Heating Resistor Wire, Nichrome Wires for Heating Elements 3.3 ft., Nichrome 60 ribbon (flat) wire ⅛″×0.010″, 0.451 ohms/ft, 25 ft spool, Coiled Nickel-Chromium Alloy Resistance Wire, NIC60-010-062-25, Resistance Heating Wire, Nickel-Chromium Alloy, 80% Nickel/20% Chromium, N180-010-50, Nichrome 60 ribbon (flat) wire 1/16″×0.0063″, 1.420 ohms/ft, 10 ft spool. Making electrical terminals: 1pc Bakelite Phenolic Round Bar Rod Diameter 10 mm, red Bakelite phenolic resin flat plate.

#6-32×½″ PAN HEAD PHILLIPS, BRASS, MACHINE SCREWS, SELECT QTY,

(100) 6-32 Brass Machine Screw Hex Nuts, Connector's: A1357-D206429-1 CONN PLUG HSNG MALE 4 POS INLINE, A1608-ND, 66101-4 CON SOCKET 16-18 AWG GOLD CRIMP, A31987-ND 1-66099-5 CONN PIN 16-18 AWG TIN CRIMP, A1360-ND 206430-1 CONN RCPT HSNG FEMALE 4 POS PNL MT, Thermocouple K Type Miniature Socket Panel Mount Alloy Plug Connector Kits US100 Vinyl Ring Terminal Connector Red 22-18 GA AWG Gauge #8 Crimp Wire 100 Pack 22-18 AWG Male & Female Fully Insulated Nylon Quick Disconnect 0.250″ UL, Fusing: [10×] 8 A 250V Fast Blow Fuse Glass Tube Fuse 8 Amp Fuse 6×30 mm, Wire: 20, 18.16 Gauge Remote Power Ground Primary Wire Cable AWG, Replacement and extensions: NEW 2M PTFE Teflon Tube 2 mm ID 4 mm OD For 1.75 mm Filament, Injection Stabilizers: 80-120 mm Shock Absorber Damper Internal Spring, Switches for relays system: 4 Pack SPST Normally Open Momentary Push Button Switch Black, Switching switches: C&K 7101 Mini Toggle Switch SPDT 2 A 250V-5 A 120V On-On 3-Pin W/Hardware, Time delays: ““OMRON”” Industrial Snap Action Switch: 10 A @ 240 V, 10 A @ 30 V, 1.1 in Ht—Snap Action Switch, DPDT, Diodes: 155Q045 15 A 45V Schottky Rectifiers Diode, R-6 5, 6 A10 1000V 6 A 1 KV Axial Rectifier Diode 6 AMP USA S/H, 10 A10 1000V 10 A 1 KV Axial Rectifier Diode 10 AMP solar panel USA, Guides: “KEY-BAK” Original Series Retractable Reel with 48 inch Kevlar Cord, Black Front, Steel Belt Clip, 8 oz. Retraction, Split Ring, Extrusion system modified: CCTREE “Creality” Ender 3 Direct Drive for Ender 3 Pro/Ender 3 V2, Comes with 42-40 Stepper Motor, Hot End Kit, 1.75 mm Direct Drive Extruder, Fan and Cables Support TPU Flexible Filament, Stepping motor driver system: DC 5-12V/15-160V Stepper Motor Drive, PWM Adjustable Stepper Motor Controller Signal Generator Speed Regulator, “DaFuRui TB6600 Stepper Motor Driver, Stepping motors: 17 Stepper Motor 42-40 Motor 1.5 A 2 Phase 4 Wires 1.8 Degree with 39.3 inch Cable, “Nema 17” Stepper Motor with Black L Stepper Motor Bracket and TB6600 4 A 9-42V Stepper Motor Driver, Relays: (2.) “SCHNEIDER ELECTRIC” General Purpose Relay: 5 Pins-Relay, SPDT, 15 A @ 277V, 15 A @ 28V, 24V DC, L. Vacuum and heat: (10) “SCHNEIDER ELECTRIC” General Purpose Relay: 14 Pins—Relay, 4 PDT, 6 A @277V, 6 A @ 28V, 12V DC, Square, Sockets “SCHNEIDER ELECTRIC” Relay Socket: L, 16 A @ 250V AC, SPST, Elevator/Finger Safe, DIN Rail, notel Not all listed as to and not limited to, “SCHNEIDER ELECTRIC”, Relay Socket: G, 10 A @ 300V AC, 4 PDT, Elevator, DIN Rail, Power supplies: “OMRON” DC Power Supply: 100 to 240 V AC, Single, 24V DC, 120 W, 5, DIN Rail, Switching, “OMRON” DC Power Supply: 100 to 240 V AC, Single, 12V DC, 60 W, 4.5, DIN Rail, “SIEMENS” DC Power Supply: 110 to 300 V DC/85 to 264 V AC, Single, 24V DC, 60 W, 2.5, DIN Rail, “THOMAS” QT40.241 Power Supply, Converters: DC-DC 6-40V to 1.2-35V 20 A 300 W Buck Converter Step-down Power Module CV CC, Mounting: Mounting Track: 35 mm DIN Rail, Thermal: Panel Meter—⅛″ DIN, Temperature, Process, “OMEGA's” DP@) series new universal panel meter, “OMEGA's” The CN4000 Series temperature/process controllers Couples/Probs, Probs: TM-902C Digital Sensor LCD Thermometer Single Input K Type Thermocouple Probe, 5TC-GG-K-20-36, Transition Junction Style Thermocouple Probes (0.010″ Ready-Made Insulated Thermocouples 5TC-GG-KI-30-2M, Bearings: Thrust Ball Bearings Steel Pin Needle Roller Bearing Sealed 3 Part, Vacuum pump, “THOMAS” Compressor/Vacuum Pump: 1/20 hp, 115V AC, 22.1 in HQ Max Vacuum, ⅛ in NPT Inlet Size

1. A machine for filament extrusion and extrusion filament retraction producing part or parts and attachment to that of flexible material as to belting, banding, elastic, and there brands an types on the market, that of a machine of lower cost, DC V compatible with low amperage use direct or none direct use of grid or off grid power supplied, fixed or portable and of extrusion to injection molding system by means manual, mechanical movement of parts of said machine and of heat management that of a system of said extrusion parts comprising:

2. a device platform, base, elevation plates, material cooling plate, material holding parts, means to hold or fasten, Parts installation panel and its parts, on demand electric switch panel, bottom mold plate, location pins, wiring described and diagrams for vacuum system and heat, top mold plate, clamping, heat and movement of bottom plate, splitting of top mold plate expansion heat management, top mold plate as to sealing, angle of relief and tip clearance to injection port, on demand heating system, system device inline base heating dc v, base heat as ac v fast warm, maintain, On demand extrusion to injection port guide, Purchased items as means to extrude, extrusion Control System that of heat means, heat means that of an attachment of extended heating contoured block and power controls that of an extrusion to injection system, extended heat system to the extrusion tip and top mold plate heat control, means of on demand temperature readings, extrusion tip, Angled Table and its componence, demand heat contact points and mount, angled table guide assembly, forward angled track assembly, forward and rear track are of the same, base and thermal prop locations, Interchangeable switch panel, switch contact rods, neg friction split of connection, vacuum valves, parts, on separate stand, power supplies, wiring to angle table componence, thermal meters, thermostats and probs, means to hold material, means to extract material and parts attached to from mold bottom plate, Filament spool feed stand, control and preheat that of filaments, Flexible material spool supply feed as described within, cooling fans, air flow lines and connectors, rubber flat, O-rings, assemble to a complete working machine as described and draw.
wherein the heat to filament density per process of extrusion to said tip can heat to larger melting points in addition to without changing said tip heat temperature settings as per material travel maintain density for drive by means of filament retraction to volume to heat with that of less heat needed to volume of said base heat to, translates that of the air flow that of heated to unit of vacuum resulting in a lower constant temperature to achieve molding and that of its attachment and that of the machine systems

3. The machine of claim 1 wherein the machine comprising materials and components listed within detailed description and general list of components, not limited to a type, components of, brand names of within patent wording are assembled that of machine screws, taped threads, bolts, nuts, washers, lock washers, wire terminals, wire connectors, wire connections, wire panel connectors, weld, soldering.

4. A humidity control and warming attachment of filament or filaments to filament spool feed stand comprising:
A base of spool feed stand, stand arm, spool arm, spool side rollers, angle bar, 4 sides and a top heat container that of larger than of a standard filament spool, container hold, filament guide round bar, 12 dc v heating element, toggle switch, temperature and humidity gage:
Wherein the filament and its spool placed on said spool arm, whereas said container placed over said spool feel stand assembly on to angle bar and container hold, toggle switch to said heat element that of heat to the container to that of control of humidity and warming of filament.

5. The A humidity control and warming attachment that of claim 5, wherein comprising of aluminum, plastic, nylon, heat element, wiring, toggle switch, temperature, and humidity gage.

6. The A humidity control and warming attachment that of claim 5, wherein the stand assembled that of fasteners, bolts, pins, container means to rivet, weld.

7. A division of neg. − direct current voltage comprising of that of two (2) sold connection poles comprising of machine screws, nuts, washers, AWG wire that of equal size to that of neg. − lead in wire and other wire that of a estimated 1 inch long.
Wherein connection of the said − lead wire and said 1 inch wire to a said sold pole with the distant end of said 1 inch wire none connected, connecting said distant end of 1 inch wire and to said current use that of restrictive, balances the current friction developing heat of that of the two (2) poles reducing the volume of heat that of a − lead wire to one (1) connection to within a fair heat range of the + pole that of the use.

8. The A division of neg. − direct current voltage of claim 7 wherein comprising of brass machine screws, washers and lock washers, AWD wire.

9. The A division of neg. − direct current voltage of claim 7 wherein connection of the said − lead wire and said 1 inch wire to a said sold pole with the distant end of said 1 inch wire none connected, connecting said distant end of 1 inch wire and to said current use that of restrictive,
